(19) United States
(12) Patent Application Publication
(10) Pub. No.: US 2007/0264512 A1
(43) Pub. Date: Nov. 15, 2007

(54) Extrusion coating process for improved adhesion to metal(lized) substrates

(76) Inventors: Sameer D. Mehta, Mason, OH (US); Richard T.E. Sylvester, Middletown, OH (US); Harilaos Mavridis, Lebanon, OH (US); Manivakkam J. Shankernarayanan, Cincinnati, OH (US)

Correspondence Address: William A. Heidrich;Equistar Chemicals, LP, 11530 Northlake Drive, Cincinnati, OH, 45249, US

(21) Appl. No.: 11/432,252

(22) Filed: May 11, 2006

(51) Int. Cl. B32B 15/08; B32B 15/20; B05D 7/00

(52) U.S. Cl. 428/461; 427/410

(57) ABSTRACT

A process for extrusion coating metal foils and metallized films which utilizes a mixture of silanated and non-silanated ethylene polymers is provided.

### BACKGROUND OF THE INVENTION

1. Field of the Invention

The present invention is directed to an extrusion coating process for the production of extrusion coated metal or metallized substrates to obtain improved adhesion of the coating to the substrate. The process utilizes a mixture of silanated and non-silanated ethylene polymers.

2. Description of the Prior Art

Extrusion coating is widely utilized to coat a variety of substrates with ethylene homopolymer and copolymer resins. For such processes, the resin is melted and formed into a thin hot coating which is uniformly spread onto a moving substrate, such as paper, plastic film, metal foil or the like. The coated substrate is then passed between rolls which press the coating against the substrate to insure uniform contact of the coating layer and substrate and good adhesion after cooling. For most commercial extrusion coating applications, the coating resin will have a melt index of about 3 g/10 min up to about 40 g/10 min measured at 190° C. and 2.16 kg. This makes it possible for the molten resin exiting the extrusion coating die to be drawn down from the die into the nip between the two rolls below the die and uniformly drawn out to the desired thickness over the entire width of the substrate.

Good adhesion of the coating to the substrate is essential and depends on a number of factors including properties of the coating resin, coating thickness and operating conditions such as melt temperature and line speed. The substrate being coated also plays a major role in the ability to achieve good adhesion. For example, it is typically more difficult to adhere extrusion coatings to smooth, non-porous substrates, such as metal foils or metallized films, than to porous substrates such as paper or cloth. Furthermore, chemical modification of metal foils and metallized films by oxidation, ozonization or similar procedures to promote adhesion is often not feasible. The application of chemical primers to the surface of such substrates is generally considered the only practical means of increasing adhesion.

It would be highly advantageous if a process were available wherein improved adhesion of extrusion coatings to metal foils and metallized films could be achieved. It would be even more advantageous if such improved adhesion could be achieved using extrusion coatings obtained utilizing conventional polyolefin resin components and without the use of primers. It would be still more desirable if it were possible to achieve increased adhesion at lower coating temperatures. This and other advantages are realized with the process of the invention.

### SUMMARY OF THE INVENTION

The present invention relates to a process for the production of extrusion coated substrates. The process utilizes an extrusion coating comprised of silanated and non-silanated ethylene polymers.

More specifically the invention is directed to a process which comprises the steps of (a) providing a silanated ethylene polymer having silane functionality incorporated in the polymer chain by copolymerization or attached to the polymer chain by grafting; (b) providing a non-silanated ethylene polymer; (c) combining (a) and (b) to obtain a mixture comprised of 1 to 70 wt. % (a) and 30 to 99 wt. % (b); (d) melt blending the mixture obtained from (c); and (e) extrusion coating at least one side of a substrate with the melt blended product produced in (d). Preferably the substrates being coated are metals or metallized films. Metal foils, such as aluminum foil, are most advantageously coated by the extrusion coating process of the invention.

Silanated ethylene polymers employed for the process preferably have 0.1 to 20 wt. % vinyltrialkoxysilane of the formula H₂C═CHSi—(OR)₃ where R is a C₁₋₄ alkyl group incorporated by copolymerization or grafting. Non-silanated polymers utilized in conjunction with the silanated ethylene polymers to produce the extrusion coating blends employed for the process include ethylene homopolymers, ethylene-C₃₋₈ α-olefin copolymers, ethylene-vinylacetate copolymers, ethylene-acrylic acid copolymers and mixtures thereof. Blends of silanated ethylene polymers with a mixture of HDPE and LDPE are particularly advantageous.

Extrusion coated metal foils or metallized films produced by the above-described process are also claimed.

### DETAILED DESCRIPTION OF THE INVENTION

The present extrusion coating process to obtain improved adhesion to metal and metallized substrates utilizes a coating composition comprised of silanated and non-silanated ethylene polymers. As employed herein, the term metal and metallized substrates refers to metal foils, such as aluminum foil, and to metallized films. The latter include films produced by deposition of a thin layer of metal on the film surface and to films obtained by laminating a metal foil to a film. The term silanated ethylene polymer refers to homopolymers and copolymers of ethylene having silane functionality incorporated in the polymer chain by copolymerization or attached to the polymer chain by grafting.

Conventional extrusion coating techniques are employed for the process of the invention. Equipment and conditions suitable for the manufacture of extrusion coated metal foils and metallized films known to the art can be used. In general, the process involves heating the extrusion coating to the desired temperature, usually in an extruder provided with a screw, and extruding it through a slot-shaped die onto the substrate being coated. While in the molten state the coating material is drawn together with the substrate between a pair of rollers forming a nip. The rollers are biased towards each other to effect good contact of the molten coating with the substrate. Normally the roller adjacent the polymer is cooled, for example by water, and the other roller is usually formed of a compressible material such as rubber. The cooled roller is generally maintained at a temperature below that at which the polymer sticks to avoid adhesion to that roller. The gap between the rollers and the speed of rotation of the rollers are varied to control the thickness of the extrusion coating layer and draw ratio.

Extrusion coating line speeds may be as high as 3500 ft/min but, more typically, are in the range 400 to 1500 ft/min. Thickness of the extrusion coating layer applied to the substrate can range from 0.2 to 1.5 mils and, more preferably, is from 0.4 to 1 mil. Operating temperatures, i.e., the temperature of the extrusion coating as it exits the die, can range from 380° F. to about 630° F. depending on the particular ethylene polymer used. An advantage of the present process is the ability to operate at lower regions in the temperature range and still obtain good adhesion of the coating to the substrate.

A comprehensive description of extrusion coating techniques and applications is provided in the technical manual published by Equistar Chemicals, LP entitled “A Guide to Polyolefin Extrusion Coating,” copyright 1997; 664/V308/Reprint December 1997, details of which are incorporated herein by reference. Extrusion coating includes extrusion lamination wherein the molten polymer is extruded between two substrates which then pass through the nip to form a laminated product in which the two substrates are bonded by the intervening extruded layer.

To obtain improved adhesion to metal/metallized substrates using the process of the invention, an extrusion coating composition which is a mixture of silanated and non-silanated ethylene polymers ethylene polymer is employed. More specifically, mixtures of ethylene polymers having silane functionality incorporated by copolymerization or grafting and one or more ethylene polymers selected from the group consisting of ethylene homopolymers, ethylene-C₃₋₈ α-olefin copolymers, ethylene-vinylacetate copolymers and ethylene-acrylic acid copolymers are employed.

Silanated ethylene polymers, also referred to herein as the silane copolymer or silane-functionalized component, utilized for the invention are ethylene polymers having silane functionality incorporated in the polymer chain by copolymerizing ethylene with a silane monomer or attached to the polymer chain by grafting a silane monomer onto an ethylene polymer.

Silane monomers which can be used for the grafting and copolymerization procedures to incorporate the silane functionality are vinyltrialkoxysilanes of the formula H₂C═CH—Si—(OR)₃ where R is a C₁₋₄ alkyl group. Vinyltrimethoxysilane (VTMOS), i.e., where R is a methyl group, and vinyltriethoxysilane (VTEOS), where R is an ethyl group, are especially useful. Silane-modified polyolefins obtained by grafting unsaturated alkoxysilanes to ethylene polymers are disclosed in U.S. Pat. No. 3,646,155 which is incorporated herein by reference. Silane-modified polyolefins obtained by copolymerizing ethylene with unsaturated alkoxysilanes are disclosed in U.S. Pat. Nos. 3,225,018 and 3,392,156, which are incorporated herein by reference.

The amount of vinyltrialkoxysilane incorporated by polymerization or grafting can range from 0.1 to 20 weight percent (wt. %) and, more preferably, will be in the range 0.5 to 7.5 wt. %. Melt indexes (MIs) of the silane-functionalized ethylene polymers can range from about 0.01 to about 100 g/10 min but are more preferably in the range 0.05 to 40 g/10 min. While densities of the silane copolymer can range from about 0.865 g/cm³ up to about 0.970 g/cm³; densities are more preferably in the range 0.915 to 0.965 g/cm³. Densities reported herein are determined in accordance with ASTM D 1505 and MIs are measured in accordance with ASTM D 1238-01, condition 190/2.16.

When the silane-functionalized component is obtained by copolymerization, one or more other olefinic monomers may also be present with the ethylene and vinyltrialkoxysilane. α-Olefin comonomers are especially useful. When present, these comonomers may constitute up to 20 wt. % of the copolymer but are more preferably present in amounts less than 10 wt. %. Illustrative comonomers which can be copolymerized with the ethylene and vinyltrialkoxysilane include: α-olefins such as propylene, butene-1, hexene-1 and octene-1; vinyl esters such as vinyl acetate and vinyl butyrate; olefinically unsaturated carboxylic acids and their esters such as methacrylic acid, acrylic acid, methyl acrylate and methyl methacrylate; vinyl ethers such as methyl vinyl ether; acrylonitrile; and the like.

When the silane-functionalized copolymer is obtained by grafting, the ethylene polymer is preferably an ethylene homopolymer or copolymer of ethylene with a C₃₋₈ α-olefin comonomer. Useful homopolymers and copolymers which can be grafted include high density polyethylene (HDPE), low density polyethylene (LDPE), very low density polyethylene (VLDPE), linear low density polyethylene (LLDPE and mLLDPE), medium density polyethylene (MDPE) and very high or ultra high molecular weight polyethylene produced using known polymerization catalysts and procedures.

Non-silanated polymer(s) combined with the silane copolymer to obtain the improved extrusion coating compositions of the invention are ethylene homopolymers and copolymers of ethylene with C₃₋₈ α-olefins, vinylacetate or acrylic acid produced by known polymerization procedures utilizing Ziegler, Phillips, metallocene or free radical catalysts. Metallocene single-site catalysts are transition metal compounds that contain cyclopentadienyl (Cp) or Cp derivative ligands (see U.S. Pat. No. 4,542,199). Non-metallocene single-site catalysts contain ligands other than Cp, usually heteroatomic ligands, e.g., boraaryl (see U.S. Pat. No. 6,034,027), pyrrolyl (see U.S. Pat. No. 5,539,124), azaborolinyl (see U.S. Pat. No. 5,756,611) and quinolinyl (see U.S. Pat. No. 5,637,660). Single-site catalysts typically produce polyethylenes having narrower molecular distributions.

Ethylene homopolymers, ethylene-C₄₋₈ α-olefin copolymers wherein the α-olefin comonomer or mixture of comonomers comprises 0.1 to 15 weight percent (wt. %) of the copolymer composition, ethylene-vinylacetate (EVA) copolymers wherein the vinyl acetate (VA) content is from 5 to 40 wt. %, ethylene-acrylic acid (EAA) copolymers wherein the acrylic acid (AA) content is from 1 to 18 wt. % and mixtures thereof are particularly useful as the non-silanated polymer component. MIs of these non-silanated ethylene polymers can range from 0.1 to 100 g/10 min and densities can range from 0.865 to 0.970 g/cm³.

In a highly useful embodiment, the ethylene-α-olefin copolymer is a copolymer of ethylene with 0.1 to 7.5 wt. % butene-1, hexene-1 or octene-1; the EVA copolymer has a VA content of 9 to 35 wt. %; the EAA copolymer has an AA content of 2 to 15 wt. %; and the ethylene homopolymer is LDPE having a density from 0.915 to 0.930 g/cm³.

In another highly useful embodiment, the non-silanated ethylene polymer component is a mixture of two or more ethylene polymer resins wherein one of the polymers is HDPE having a density in the range 0.941 to 0.970 g/cm³. Densities of the HDPE are more preferably from 0.943 to 0.968 g/cm³ and, most preferably, from 0.945 to 0.966 g/cm³. The HDPE component will have a MI from 2 to 100 g/10 min and, more preferably, from 4 to 60 g/10 min. The use of blends containing HDPE are advantageously employed for applications where extrusion coatings having enhanced stiffness are desired.

Particularly useful extrusion coatings are obtained when the non-silanated ethylene polymer component is a mixture of LDPE and HDPE. MIs of the LDPE preferably range from 1 to 40 g/10 min and densities are preferably in the range 0.917 to 0.928 g/cm³. LDPE homopolymers are particularly useful for these blends.

The above-described silanated and non-silanated components are typically dry-blended at the desired weight ratio and then melt blended by conventional means, such as in an extruder or Banbury mixer. The resulting melt blended composition may be directly extrusion coated onto the substrate or the blend may be pelletized and stored for subsequent extrusion coating.

Blends utilized for the process of the invention and which exhibit improved adhesion to metal foils and metallized films contain 30 to 99 wt. % non-silanated polymer and 1 to 70 wt. % of the silane-functionalized component. Extrusion coating blends comprised of 50 to 95 wt. % of the non-silanated polymer component and 5 to 50 wt. % of the silane copolymer are particularly useful. The above weight percentages are based on the total weight of the extrusion coating blend. It is even more advantageous when the extrusion coating blends have MIs from 0.1 to 50 g/10 min and the silane copolymer component is a silanated ethylene polymer obtained by copolymerization or grafting using VTMOS or VTEOS.

When the non-silanated polymer component is a mixture of HDPE with one or more other ethylene (co)polymers, e.g., LDPE, the weight ratio of HDPE to other ethylene (co)polymer will range from 10:1 to 1:10 and, more preferably, be in the range 5:1 to 1:5.

Whereas the process of the invention is suitable for extrusion coating a variety of substrates, e.g., fabrics, paper products and plastic materials, it is particularly advantageous for coating metal foils, such as aluminum foil, and metallized films. Extrusion coated metal/metallized substrates are commonly used for snack food packaging, pet food packaging, medical packaging and stand-up pouches. Moreover, it has been observed when extrusion coating metal/metallized substrates in accordance with the process of the invention that significantly improved adhesion at low coating temperatures is possible.

The following examples illustrate the improved extrusion coating process of the invention and the improved adhesion obtained using the silanated/non-silanated polymer extrusion coating blends. Those skilled in the art, however, will recognize numerous possible variations which are within the spirit of the invention and scope of the claims.

The extrusion coated blends utilized for these examples were prepared by dry-blending the silanated polymer and non-silanated components in the proportions indicated. The dry-blended mixtures were then extrusion coated using a commercial-sized coating line operating at a rate of 400 ft/min using a 3½″ Black-Clauson single screw extruder (L/D 30:1; screw speed 76-83 rpm).

Coatings were applied at a thickness of 10 lbs/ream at 590° F. and 610° F. (the temperature at the combining adapter, die and die lips) to demonstrate the effect of different operating conditions on adhesion of the coating layer to the substrate. Temperature (in ° F.) within the extruder (6 heating zones) for these two modes of operation were as follows:

| | 590° F. | 610° F. |
|---|---|---|
| Z1 | 400 | 400 |
| Z2 | 485 | 525 |
| Z3 | 575 | 575 |
| Z4 | 585 | 610 |
| Z5 | 585 | 610 |
| Z6 | 580 | 610 |

The following were utilized to prepare the extrusion coating blends employed for the examples:

HDPE: a commercially available ethylene-octene-1 copolymer having a density of 0.960 g/cm³ and MI of 18 g/10 min.

LDPE: a commercially available ethylene homopolymer having a density of 0.923 g/cm³ and MI of 4.5 g/10 min.

Silane Copolymer: a commercially available ethylene-vinyltrimethoxysilane copolymer obtained by copolymerizing ethylene with 1.7 wt. % VTMOS and having a density of 0.923 g/cm³ and MI of 1.5 g/10 min.

To demonstrate the improved adhesion to metal/metallized substrate obtained at lower coating temperatures with the process of the invention, aluminum foil was extrusion coated at 590° F. and 610° F. using an extrusion coating blend of the invention and an extrusion coating which contained no silane copolymer. The extrusion coating of the invention was comprised of 28 wt. % HDPE, 42 wt. % LDPE and 30 wt. % silane copolymer whereas the comparative extrusion coating contained only HDPE (35 wt. %) and LDPE (65 wt. %). Weight ratios of HDPE:LDPE used were comparable. Both the inventive blend and the comparative blend were extrusion coated onto 24 inch wide aluminum foil having a thickness of 0.0003 mil.

The resulting coated Al foils were then tested to determine adhesion of the coating to the metal substrate. The adhesion strength between the coating and the substrate was measured on a MTS Alliance universal testing machine with 200 lb. load cells.

Whereas both the inventive blend and the comparative blends had good adhesion to the Al foil when coated at the higher temperature, i.e., 610° F., i.e., cohesive failure occurred before the coating separated from the Al foil substrate, only the inventive blend gave acceptable results at the lower (590° F.) coating temperature.

Al foil extrusion coated at 590° F. using the comparative two-component (HDPE/LDPE) blend had only 36 grams per inch adhesion. On the other hand, Al foil coated at 590° F. using the inventive blend had adhesion comparable to that obtained at 610° F. Of four samples tested, no separation was possible with three of the samples (i.e., cohesive failure occurred before the extrusion coating separated from the Al foil) and the adhesive strength of the remaining sample was 770 grams per inch. The improved adhesion obtained at lower coating temperatures with the process of the invention utilizing a combination of silanated and non-silanated polymers is readily apparent from the above data.

Comparable improvement in adhesion is obtained using extrusion coating blends of HDPE, LDPE and PE grafted with VTMOS and blends of silane-functionalized ethylene polymers with EVA and/or EAA.

We claim:

1. A process for the production of extrusion coated substrates comprising:
(a) providing a silanated ethylene polymer having silane functionality incorporated in the polymer chain by copolymerization or attached to the polymer chain by grafting;
(b) providing a non-silanated ethylene polymer;
(c) combining (a) and (b) to obtain a mixture comprised of 1 to 70 wt. % (a) and 30 to 99 wt. % (b);
(d) melt blending the mixture obtained from (c);
(e) extrusion coating at least one side of a substrate with the melt blended product produced in (d).

2. The process of claim 1 wherein the substrate is a metal foil or metallized film.

3. The process of claim 1 wherein (b) the melt blended product obtained from (d) is pelletized prior to extrusion coating.

4. The process of claim 1 wherein (a) has from 0.1 to 20 wt. % vinyltrialkoxysilane of the formula H₂C═CHSi—(OR)₃ where R is a C₁₋₄ alkyl group incorporated by copolymerization or grafting.

5. The process of claim 4 wherein (a) contains 0.5 to 7.5 wt. % VTMOS or VTEOS.

6. The process of claim 4 wherein (b) is selected from the group consisting of ethylene homopolymers, ethylene-C₃₋₈ α-olefin copolymers, ethylene-vinylacetate copolymers, ethylene-acrylic acid copolymers and mixtures thereof.

7. The process of claim 6 wherein (b) is an ethylene homopolymer.

8. The process of claim 7 wherein (b) is an LDPE homopolymer.

9. The process of claim 6 wherein (b) is a copolymer of ethylene with butene-1, hexene-1 or octene-1.

10. The process of claim 6 wherein (b) is an ethylene-vinylacetate copolymer having a vinyl acetate content of 5 to 40 wt. %.

11. The process of claim 6 wherein (b) is an ethylene-acrylic acid copolymer having an acrylic acid content of 1 to 18 wt. %.

12. The process of claim 6 wherein (b) is a mixture of HDPE and one or more other ethylene (co)polymers present at a weight ratio of 10:1 to 1:10.

13. The process of claim 12 wherein (b) is a mixture of HDPE and LDPE present at a weight ratio from 5:1 to 1:5.

14. The process of claim 6 wherein the mixture (c) is comprised of 5 to 50 wt. % (a) and 50 to 95 wt. % (b).

15. An extrusion coated metal foil or metallized film produced by the process of claim 1.

16. Extrusion coated aluminum foil produced by the process of claim 1.
